(19) United States
(12) Patent Application Publication
(10) Pub. No.: US 2013/0133606 A1
(43) Pub. Date: May 30, 2013

(54) DEVICE APPLIED IN START-UP UNIT THAT CONSTANTLY WORKS GEARED TO THE MAIN ENGINE

(71) Applicants: FERNANDO COMANDOLLI, Brusque (BR); MARCELO PEREGRINA GOMEZ, Brusque (BR)

(72) Inventors: FERNANDO COMANDOLLI, Brusque (BR); MARCELO PEREGRINA GOMEZ, Brusque (BR)

(73) Assignee: ZEN SA INDUSTRIA METALURGICA, Brusque (BR)

(21) Appl. No.: 13/423,271

(22) Filed: Mar. 18, 2012

(30) Foreign Application Priority Data
Mar. 18, 2011 (BR) MU9100610-4

(51) Int. Cl. F02N 15/02

(52) U.S. Cl. CPC F02N 15/02
USPC 123/179.4

(57) ABSTRACT

The present model describes the technical field of parts for the automobile sector, more specifically a device applied in the starter unit that constantly works geared to the main engine. The new model presents a start-up unit that works with a drive gear constantly engaged to the gear train of the main engine; a torque transmission system and free wheel (2) with rollers (5C) and cam (5A2); and a rubber damping system (8) to avoid damages to the start-up system when the combustion engine turns off due to kickback that is a characteristic present in all combustion and explosion engines.

### PRESENTATION

The present model describes the technical field of parts for the automobile sector, more specifically a device applied in the starter unit that constantly works geared to the main engine. The new model presents a start-up unit that works with a drive gear constantly engaged to the gear train of the main engine; a torque transmission system and free wheel with rollers and cam; and a damping system to avoid damages to the start-up system when the combustion engine turns off due to kickback that is a characteristic present in all combustion and explosion engines.

Through the new devices, the start-up unit obtains gains and improvements in the manufacture and resistance of the equipment, as well as more efficiency in the freewheel system.

### BACKGROUND

In practically all vehicles that have internal combustion and explosion engines there is the presence of an electric start-up engine. This, in turn, is made up of two parts, an electric part and a mechanical part. The electric part basically consists of a solenoid and an armature. The mechanical part is responsible for the casing, linkage lever and starter.

The starter has the primary function of transmitting torque from the electric engine to the internal combustion engine. This torque is limited by the construction of the starter and materials used.

The combustion engines have a minimum rotation regime to operate called slow run, this being at least twice greater than the start-up rotation. Due to this condition, the starter has a secondary function called freewheel, which is highly important to avoid the over-rotation of the start-up engine.

### STATE OF THE ART

The U.S. Pat. No. 5,199,309 “START-UP UNIT” Isozumi describes and claims a starter with engine, planetary gears, among other elements, however this patent works with the normal working principle of a traditional propeller. Where, by closing the electric contact of the ignition switch, the solenoid is driven, making the propeller “displace forward”, and therefore “gearing the pinion and rack”; then the electric engine is driven transmitting torque and movement to the combustion engine; after the engine starts operating, the starter enters freewheel and by releasing the ignition key, the starter engages the rack, returning to the initial position.

U.S. Pat. No. 7,219,569 B2 “INTEGRAL ONE-WAY OVERRUN CLUTCH WITH EPICYCLE GEAR SYSTEM” Jastrzembowski, claims a starter containing an electric engine, clutches, reducers by planetary gears, that is: elements similar to the previous patent and to many models of the existing start-up unit. In this invention, the freewheel system of the pinion was transferred for reduction by the planetary gear, but the main function remains the same. The patent mentions that the size of the electric engine can be reduced because the starter is located in a compartment outside the electric engine, that is, two separate assemblies. For this reason as well as the size reduction of the electric engine, they informed the size reduction of the engine, vibration, sound and noise as gain. The functioning principle is the same as mentioned above (the starter gear advances to the drive gear of the crankshaft and returns after the engine starts to operate).

Due to the forward movement of the pinion of the starter on the rack of the wheel, there may be “cog to cog” collisions, a fact that may result in a bad start-up attempt because the solenoid cannot complete its displacement, preventing the closing of the contacts and preventing the activation of the electric engine.

All existing starter models specifically work with direct activation on the flywheel rack.

Another problem presented in this dry pinion gearing, with flywheel rack, situation that makes coupling difficult and reduces the useful life of the parts in contact due to external agents.

Based on the current characteristics of the starters, the useful life is limited, making its manufacture and improvements financially unfeasible.

PI0804052-4 A2 “Start-up unit for constantly engaged/coupled combustion engines” by the same “inventor and applicant” differs from the other models found in the current state of the art, where the improvements presented are:

- the start-up unit is different from the traditional start-up engines because it is a component of the combustion engine installed in the basic engine.

- it does not work on the flywheel gear, therefore: enables the elimination of the rack, reduces the complexity of the wheel, reduces the weight and reduces the cost and time of manufacture;

- discards the use of fork, solenoid, some electric cables and eliminates the restrictions of the project caused by the application of the start-up engine.

- presents a simple construction of the components and reduces the weight in relation to the other start-up engines;

- the system presents a much simpler and efficient solution for start-up combustion engines due to the fact that the system remains constantly engaged and mounted inside the combustion engine;

- the system is always bathed in oil, which reduces the friction between the moving parts and prevents contamination of the system by external agents; and

- the noise is reduced considerably.

### SUMMARY

The present model has the same principle as PI0804052-4 A2, where the start-up unit remains constantly engaged and coupled to the engine. However, it has a new device in the clutch(s) that operates with rollers and cam, providing the freewheel system with more resistance and efficiency; a damping system to avoid damages to the start-up system; and new devices in the internal parts of the unit that when united make up a more efficient, economic, silent and longer lasting start-up system.

Through executed tests (resistance, efficiency, noise and durability), the proposed model showed to be more efficient compared to the previous model.

### DESCRIPTION OF THE MODEL

The start-up unit comprises an electric engine, a back bearing, where two planetary gear assemblies are positioned (each consisting of a crown, satellite gears and planetary pins), a shaft with sun gear and bushings; a front bearing, two rollers, pressure rings, washers, and a drive gear, consisting of the drive gear of the unit, working constantly engaged to the gear train of the main engine; for having a new device in the assembly of the freewheel system that operates with rollers and cam, and for presenting a rubber damping system to avoid damages to the start-up system.

### Description of the Operation

The present model starts operating when the start-up key of the combustion engine is turned. The start-up key transfers current to the electric, which in turn puts the armature into motion. This movement is transferred to the reduction system by planetary gears that modify the torque and output rotation of the system, making it ideal for the combustion engine to start operating. After reductions by the planetary gears, there is a cam and rollers system that has the function of transmitting torque in one of the rotation directions and freewheel in the opposite direction;

The rollers are always being forced by the spring to stay in contact with the shaft and cam to ensure the mechanical contact in the direction of the lock torque.

At this instant the torque is being transmitted directly to the combustion engine because the gear rotation of the start-up unit is the same as the rotation of the combustion engine, and then the rollers remain in contact with the shaft and cam, transmitting the torque from the electric motor to the shaft geared to the combustion engine.

The instant the combustion/explosion engine starts to enter into operation, the speed of the gear, shaft and one-way clutches starts to become greater than the rotation of the rest of the start-up system, then the roller system enters into freewheel.

When the motor starts operating and reaches the slow run, the inertia generated in the rollers through the rotation in the one-way clutch overcomes that of the spring and disconnects the rollers from the cam and shaft, which enables the friction between the roller and shaft to be completely eliminated.

Once the motor starts operating, the user of the engine stops the start-up by turning the start-up key to the neutral position. At this instant the electric engine is de-energized, ceasing the movement of the armature and consequently the planetary gears. Therefore, only part of the system (gear, shaft and one-way clutches) continues to move coupled to the combustion engine and to work in freewheel in relation to the rest of the start-up system.

Due to the kickback, which is a characteristic present in all combustion and explosion engines, characterized by the turning of the combustion engine in the opposite direction to its normal operation that occurs when the combustion engine is turned off, a rubber damping system was used to avoid damages to the start-up system because when the kickback occurs the freewheel of the start-up system locks and receives an impact from the combustion engine. With the application of this damping system, damage to the system is avoided.

### DESCRIPTION OF THE DRAWINGS

The objectives, advantages and other important characteristics of the present model can be easily understood when read together with the attached figures, which are:

FIG. 01 shows an exploded view of the start-up unit that works permanently geared to the main engine.

FIG. 02 shows a perspective view of the start-up unit that works permanently geared to the main engine.

FIG. 03 shows side section view of the start-up unit that works permanently geared to the main engine.

FIG. 04 shows a top section view of the start-up unit that works permanently geared to the main engine.

FIG. 05 shows a top section view of the freewheel system of the start-up unit that works permanently geared to the main engine.

FIG. 06 shows an exploded view of the freewheel system of the start-up unit that works permanently geared to the main engine.

FIG. 07 shows a view of the installation of the start-up unit, which shows the coupling of the gear in the engine gear train.

FIG. 8 shows a view of the installation of the start-up unit in the engine.

FIG. 09 shows a view of the installation of a starter found in the current start of the art, which shows the displacement of the pinion on the flywheel rack.

### DETAILED DESCRIPTION

As shown in the figures in annex that illustrate and integrate the present model of “Device Applied in Start-Up Unit that Constantly Works Geared to the Main Engine”, it is a start-up unit (1) used to transmit initial torque to the combustion engine (M), consisting of drive gear (9), constantly working engaged to the gear train (T) of the main engine (M); it contains a new device in the freewheel assembly (2) that operates with rollers (5C) and cam (5A2), and having a rubber damping system (8), and reduces the bumps in the engine and therefore, avoids damages in the start-up unit (1).

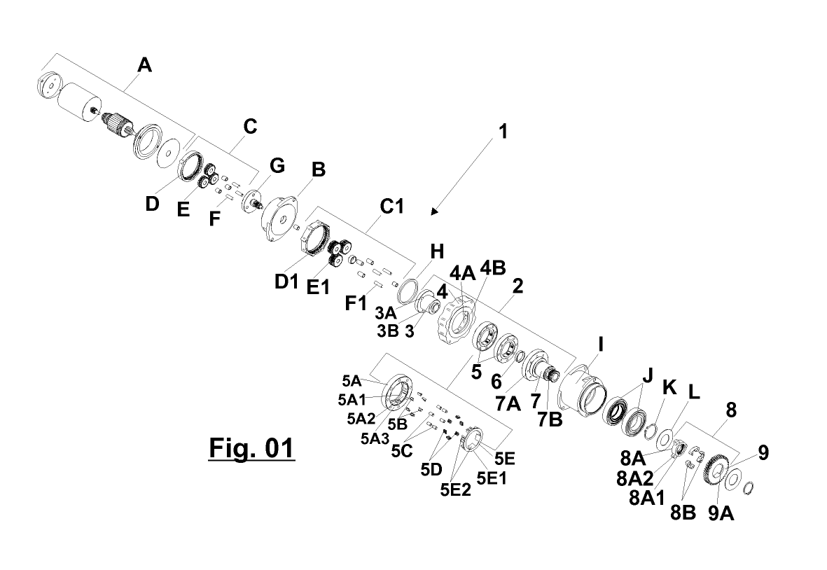

The FIG. 01 shows the start-up unit (1) in an exploded view, showing the following: the electric engine (A); a back bearing (B); where a planetary gear assembly (C) is located in the internal part (each consisting of a crown (D), satellite gears (E) and planetary pins (F)), and on the outer part, a planetary gear assembly (C1) (each consisting of a crown (D1), satellite gears(E1) and planetary pins (F1)); a shaft with sun gear (G) and bushing ring (H); a freewheel system assembly (2), consisting of a cylindrical shaft (3) with spare cylindrical base (3A) having three holes (3B); an intermediary cylindrical bearing (4), contained inside the semi-cylindrical cavities (4A), to insert the projections of the crown (D1), and a bearing ring (4B), for the spare cylindrical base (3A); two one-way clutches (5), each consisting of a cylindrical compartment (5A), equipped with a fixed ring (5A1), internal walls with cam (5A2), and a lock ring (5A3) of the internal assembly, which consists of spring guides (5B) made up of rectangular bases and oblong pins, rollers (5C), oblong springs (5D) and a plastic template (5E), equipped with a ring (5E1) and support guides (5E2), a cylindrical bushing (6), and a spline shaft (7), equipped with a spare cylindrical base (7A) with holes (7B) for locking in the one-way clutches (5) and the spline end (7C); in the front part o the freewheel system assembly (2) is a front bearing (I); two rollers (J); a pressure ring (K); a washer (L); and a damping system assembly (8), consisting of a coupling part (8A) in cylindrical form containing splines (8A1) in the internal part for inserting the end with splines, (7B) of the spline shaft (7) and three rods (8A2) on the outer edges, to insert the damping rubbers (8B), which are inserted in the cavities (9A) of the internal walls of the drive gear (9).

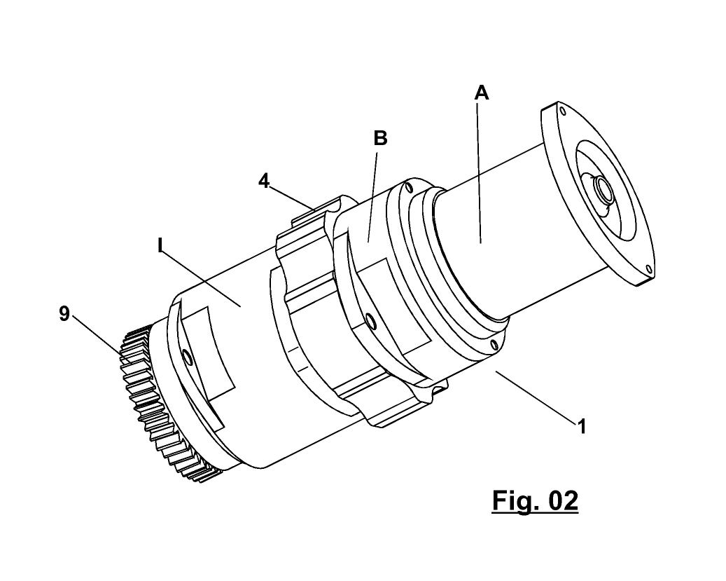

FIG. 02 shows the perspective view of the start-up unit (1), which shows the electric engine (A); the back bearing (B); intermediary bearing (4); front bearing (I); and the drive gear (9).

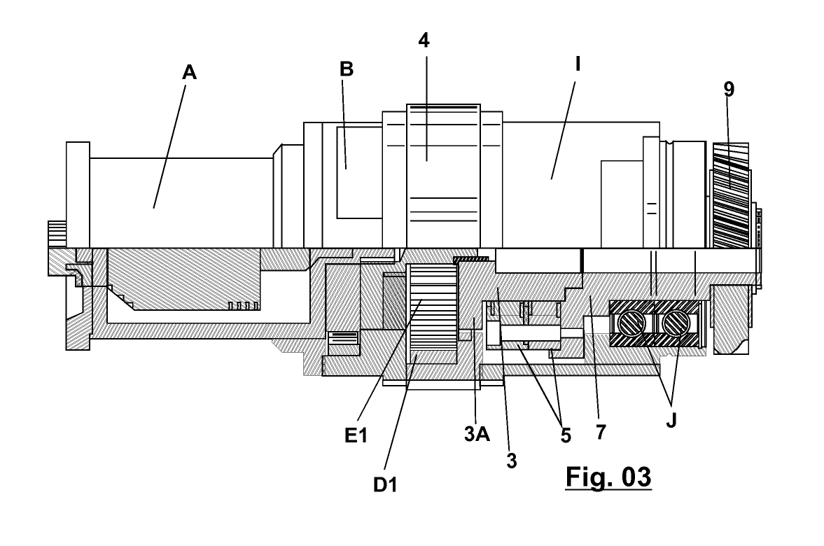

FIG. 03 shows the section view of the start-up unit (1), showing on the external part the electric engine (A), back bearing (B); intermediary bearing (4), front bearing (I), and the drive gear (9); and the internal part showing the crown (D1), satellite gears (E1), cylindrical shaft (3) with spare cylindrical base (3A), the one-way clutches (5), spline shaft (7) and the rollers (J).

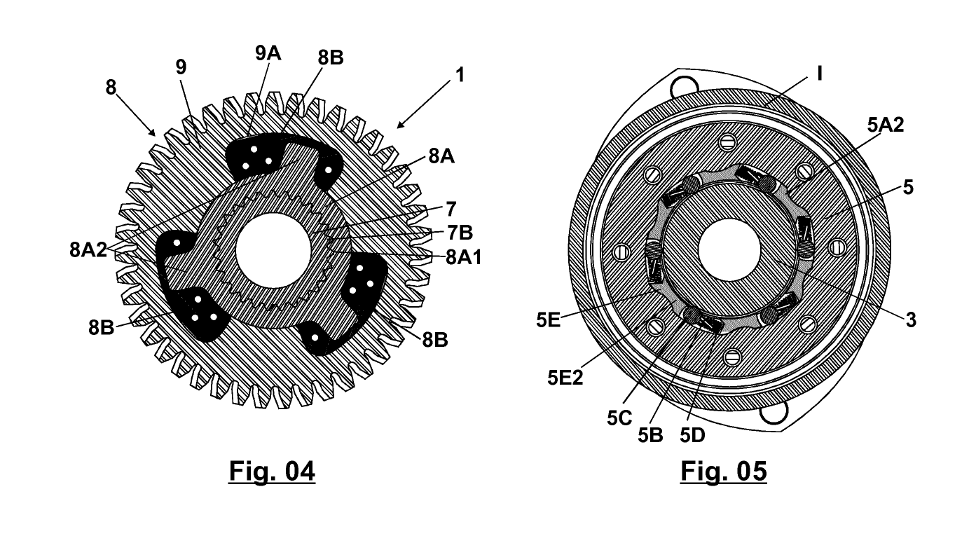

FIG. 04 shows the top view of the damping system (8), which shows the coupling (8A) in the internal part to insert the end with the spline (7B) of the spline shaft (7) and three rods (8A2) on the external edges, to insert the damping rubbers (8B), which are inserted in the cavities (9A) of the internal walls of the drive gear (9).

FIG. 05 shows the section view of the freewheel system (2), which shows the cylindrical shaft (3); one-way clutch (5), with the internal walls with cam (5A2); spring guides (5B); rollers (5C); oblong springs (5D); the cage (5E), with the housings (5E2); and the front bearing (I).

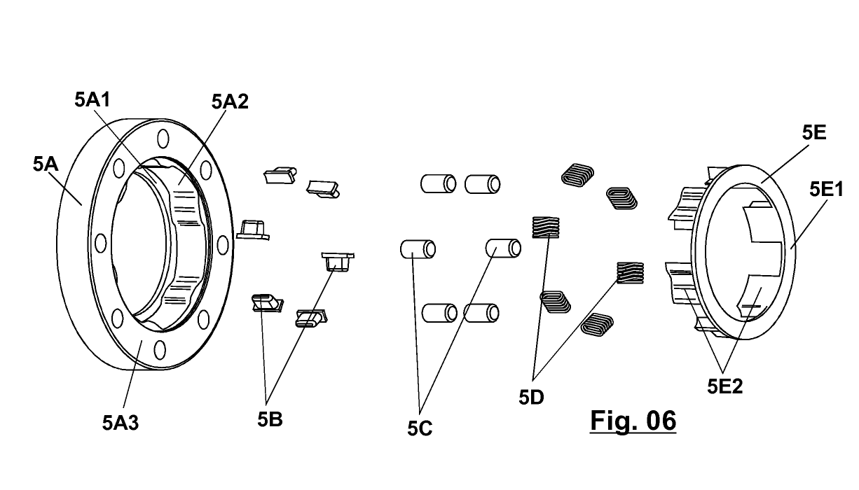

The FIG. 06 shows the exploded view of the one-way clutch (5), showing the cylindrical compartment (5A), equipped with a fixed ring (5A1), internal walls with cam (5A2), a lock ring (5A3) of the internal assembly, which consist of spring guides (5B) comprising rectangular bases and oblong pins, rollers (5C), oblong springs (5D) and a cage (5E), equipped with a ring (5E1) and guide supports (5E2).

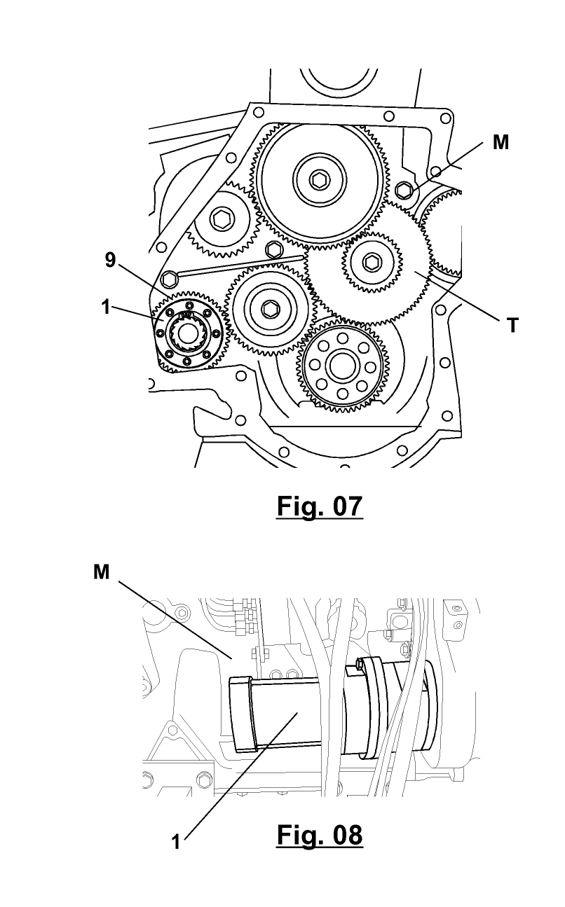

FIGS. 07 and 08 shows the installation of the start-up unit (1), which shows the drive gear (9) constantly engaged to the gear train (T) of the main engine (M), more specifically in the power socket.

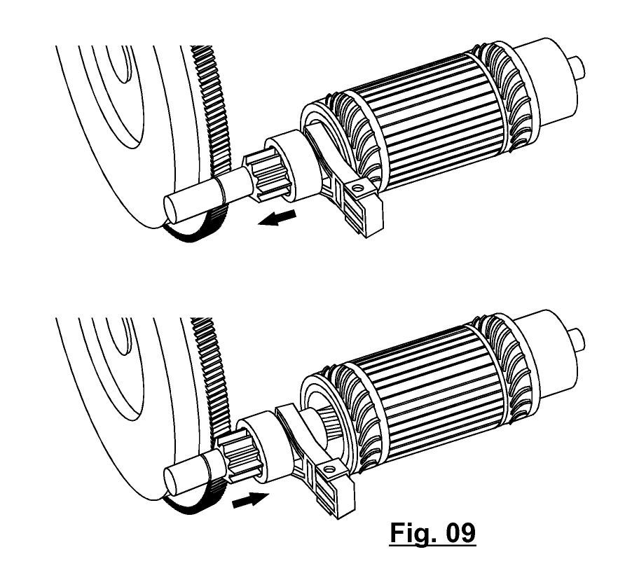

FIG. 09 shows a starter found in the current start of the art, which shows the displacement of the pinion on the flywheel rack.

This start-up unit aims to show reduction in manufacturing cost, performance improvement, considerably noise reduction, life increase, and elimination of some of the existing components in the conventional start-up system.

The parts of this assembly can vary in size, shapes and materials to adapt to any type of start-up unit system, but always maintaining the same characteristics of the present model.

In view of the arguments that have been stated herein, it is a product that will be well received by assemblers and final consumers because it is an extremely efficient and economic product that has several improvements in relation to the current systems.

It is claimed:

1. “DEVICE APPLIED IN START-UP UNIT THAT CONSTANTLY WORKS GEARED TO THE MAN ENGINE”, to be applied as a start-up system in combustion or similar engines, comprising a start-up unit (1), which works with the drive gear (9) constantly engaged to the gear train of the main engine; for having a new device in the freewheel system assembly (2) that operates with rollers (5C) and cam (5A2), transmitting the torque in one rotation direction, and turning in freewheel in the opposite direction by the centrifugation principle of the rollers, and for presenting a rubber damping system (8) to avoid damages to the start-up system when the combustion engine is turned off due to kickback, which is a characteristic present in all combustion and explosion engines.)

2. “DEVICE APPLIED IN START-UP UNIT THAT CONSTANTLY WORKS GEARED TO THE MAN ENGINE”, according to claim 1 comprising: the freewheel system assembly (2) that consists of a cylindrical shaft (3) with a spare cylindrical base (3A) with three holes (3B); a cylindrical intermediary bearing (4) equipped with internal semi-cylindrical cavities (4A), to insert the projections of the crown (D1), and a bearing ring (4B), for the spare cylindrical base (3A); two one-way clutches (5), one cylindrical bushing (6), and one spline shaft (7), equipped with a spare cylindrical base (7A), with holes (7B) for locking in the one-way clutches (5) and an end with spline (7B).)

3. “DEVICE APPLIED N START-UP UNIT THAT CONSTANTLY WORKS GEARED TO THE MAN ENGINE”, according to claim 2, comprising the one-way clutch (8), consisting of a cylindrical compartment (5A), equipped with a fixed ring (5A1), internal walls with cam (5A2), a lock ring (5A3) of the internal assembly, which consist of spring guides (5B) comprising rectangular bases and oblong pins, rollers (5C), oblong springs (5D) and a plastic template (5E), equipped with a ring (5E1) and guide supports (5E2).)

4. “DEVICE APPLIED N START-UP UNIT THAT CONSTANTLY WORKS GEARED TO THE MAN ENGINE”, according to claim 1, comprising: the start-up unit (1) containing one or more one-way clutches (5).)

5. “DEVICE APPLIED N START-UP UNIT THAT CONSTANTLY WORKS GEARED TO THE MAN ENGINE”, according to claim 1, comprising the damping system (8), which consists of a cylindrical coupling part (8A) containing splines (8A1) in the internal part, to insert the end with the spline (7B) of the spline shaft (7) and three rods (8A2) on the external edges, to insert the damping rubbers (8B), which are inserted in the cavities (9A) of the internal walls of the drive gear (9).
